(19) United States
(12) Patent Application Publication
(10) Pub. No.: US 2026/0121310 A1
(43) Pub. Date: Apr. 30, 2026

(54) CONNECTOR AND CONNECTOR ASSEMBLY

(71) Applicant: Japan Aviation Electronics Industry, Limited, Tokyo (JP)

(72) Inventor: Osamu HASHIGUCHI, Tokyo (JP)

(21) Appl. No.: 19/293,631

(22) Filed: Aug. 7, 2025

(30) Foreign Application Priority Data
Oct. 31, 2024 (JP) 2024-191907

(51) Int. Cl. H01R 4/48; H01R 4/70

(52) U.S. Cl. CPC H01R 4/4863; H01R 4/70

(57) ABSTRACT

A connector includes a housing, a contact that is retained by the housing, and a locator that is retained by the housing to cover a front surface of the housing, and when the connection object is not pressed to the connector, a first extending portion of a movable portion of the contact projects from the locator, and a second extending portion having a second width wider than a first width of the first extending portion is situated inside a movable portion insertion hole of the locator, and when the connection object is pressed to the connector, a counter contact of the connection object makes contact with a first connection portion and pushes the first connection portion, whereby a first plunger is elastically displaced so that the first extending portion is situated inside the movable portion insertion hole of the locator.

### BACKGROUND OF THE INVENTION

The present invention relates to a connector, particularly to a connector that is connected to a connection object by an operation of pressing the connection object in a predetermined pressing direction.

The present invention also relates to a connector assembly including such a connector and such a connection object.

As a connector of this type, for example, JP 2024-035498 A discloses a connector 3 in which a large number of conductive probe pins 2 are retained by a housing 1 as illustrated in FIG. 27. Each probe pin 2 has a first plunger 2A and a second plunger 2B that are pressed in opposite directions from each other by means of an internal spring.

When the connector 3 is disposed between an interposer 4 and a substrate 5 and the substrate 5 is pressed relatively toward the interposer 4, a tip of each first plunger 2A makes elastic contact with a terminal of a wiring layer 4A of the interposer 4 so that the first plunger 2A is electrically connected to the terminal of the wiring layer 4A of the first plunger 2A, and a tip of each second plunger 2B makes elastic contact with a terminal of a wiring layer 5A of the substrate 5 so that the second plunger 2B is electrically connected to the terminal of the wiring layer 5A.

Thus, a large number of terminals of the wiring layer 5A of the substrate 5 are connected to a large number of terminals of the wiring layer 4A of the interposer 4 via a large number of the probe pins 2.

Therefore, the first plunger 2A of the probe pin 2 connected to the terminal of the wiring layer 4A of the interposer 4 is connected to a corresponding bump electrode 6A of a chip substrate 6 via the interposer 4.

Since the first plunger 2A and the second plunger 2B of each probe pin 2 are elastically movable along the pressing direction of the interposer 4 and the substrate 5, even when positional deviation occurs in the pressing direction among a large number of the terminals of the wiring layer 4A of the interposer 4, a large number of the probe pins 2, and a large number of the terminals of the wiring layer 5A of the substrate 5 due to their manufacturing tolerances or the like, the positional deviation is absorbed, so that the electrical connection state can be ensured.

However, when positional deviation along the planar direction of the wiring layers 4A and 5A orthogonal to the pressing direction is present among a large number of the terminals of the wiring layer 4A of the interposer 4, a large number of the probe pins 2, and a large number of the terminals of the wiring layer 5A of the substrate 5, it is difficult to absorb the positional deviation, and the reliability of electrical connection may be impaired.

### SUMMARY OF THE INVENTION

The present invention has been made to overcome the conventional problems as above and aims at providing a connector capable of ensuring the reliability of electrical connection even when positional deviation occurs between the connector and a connection object in a direction orthogonal to the pressing direction.

The present invention also aims at providing a connector assembly including such a connector and a connection object.

A connector according to the present invention is a connector that is connected to a connection object by an operation of pressing the connection object to the connector along a predetermined pressing direction, the connector comprising:
a housing that is made of an insulating material and has a front surface facing the connection object;
a contact that is conductive, is retained by the housing, and extends along the pressing direction; and
a locator that is made of an insulating material and retained by the housing to cover the front surface of the housing,
wherein the contact includes a movable portion that is elastically displaceable in the pressing direction with respect to the housing and that at least partly projects from the locator toward the connection object,
wherein the movable portion includes:
   a front end portion facing the connection object along the pressing direction;
   a first connection portion disposed at the front end portion;
   a first extending portion extending from the first connection portion in an opposite direction opposite from the front end portion along the pressing direction and having a first width in an orthogonal direction orthogonal to the pressing direction; and
   a second extending portion extending from the first extending portion in the opposite direction from the front end portion along the pressing direction and having a second width wider than the first width in the orthogonal direction,
wherein the locator has a movable portion insertion hole that allows the second extending portion of the movable portion to be inserted therethrough,
wherein when the connection object is not pressed to the connector, the second extending portion is situated inside the movable portion insertion hole of the locator, and the first extending portion projects from the locator toward the connection object, and when the connection object is pressed to the connector, a counter contact of the connection object makes contact with the first connection portion and pushes the first connection portion in the pressing direction, whereby the movable portion is elastically displaced in an opposite direction from the connection object so that the first extending portion is situated inside the movable portion insertion hole of the locator.

A connector assembly according to the present invention comprises:
the foregoing connector; and
the connection object.

### BRIEF DESCRIPTION OF THE DRAWINGS

FIG. 1 is a perspective view showing a connector of Embodiment 1 when mounted on a mounting substrate.

FIG. 2 is a plan view showing the connector of Embodiment 1 mounted on the mounting substrate.

FIG. 3 is a side view showing the connector of Embodiment 1 mounted on the mounting substrate.

FIG. 4 is a side view showing the connector of Embodiment 1 mounted on the mounting substrate as seen from a direction different from that of FIG. 3.

FIG. 5 is an exploded view of the connector of Embodiment 1.

FIG. 6 is a perspective view showing a housing used in the connector of Embodiment 1.

FIG. 7 is a perspective view showing a locator used in the connector of Embodiment 1.

FIG. 8 is a plan view showing the locator used in the connector of Embodiment 1.

FIG. 9 is a perspective view showing a contact used in the connector of Embodiment 1.

FIG. 10 is a cross-sectional view showing the contact used in the connector of Embodiment 1.

FIG. 11 is a perspective view showing a mounting substrate on which the connector of Embodiment 1 is to be mounted.

FIG. 12 is a cross-sectional view taken along line A-A in FIG. 2.

FIG. 13 is a cross-sectional view taken along line B-B in FIG. 2.

FIG. 14 is a perspective view showing a connection object.

FIG. 15 is a side view showing the connector and the connection object of Embodiment 1 in a state where the connection object is not pressed.

FIG. 16 is a perspective view showing the connector and the connection object of Embodiment 1 in a state where the connection object is pressed.

FIG. 17 is a plan view showing the connector and the connection object of Embodiment 1 in the state where the connection object is pressed.

FIG. 18 is a cross-sectional view taken along line C-C in FIG. 17.

FIG. 19 is a cross-sectional side view showing the connector and the connection object of Embodiment 1 in the state where the connection object is pressed, as seen from a direction different from that of FIG. 18.

FIG. 20 is a cross-sectional side view showing the connector and the connection object of Embodiment 1 in the state where the connection object is not pressed when positional deviation occurs between the connector and the connection object of Embodiment 1.

FIG. 21 is a cross-sectional side view showing the connector and the connection object of Embodiment 1 in the state where the connection object is pressed with positional deviation between the connector of Embodiment 1 and the connection object.

FIG. 22 is a perspective view showing a contact used in a connector of Embodiment 2.

FIG. 23 is a perspective view showing a connection object in Embodiment 2.

FIG. 24 is a side view showing the connection object in Embodiment 2.

FIG. 25 is a perspective view showing the connector and the connection object of Embodiment 2 in a state where the connection object is pressed.

FIG. 26 is a cross-sectional side view showing the connector and the connection object of Embodiment 2 in the state where the connection object is pressed.

FIG. 27 is a cross-sectional side view showing a conventional connector.

### DETAILED DESCRIPTION OF THE INVENTION

Embodiments of the invention are described below based on the accompanying drawings.

### Embodiment 1

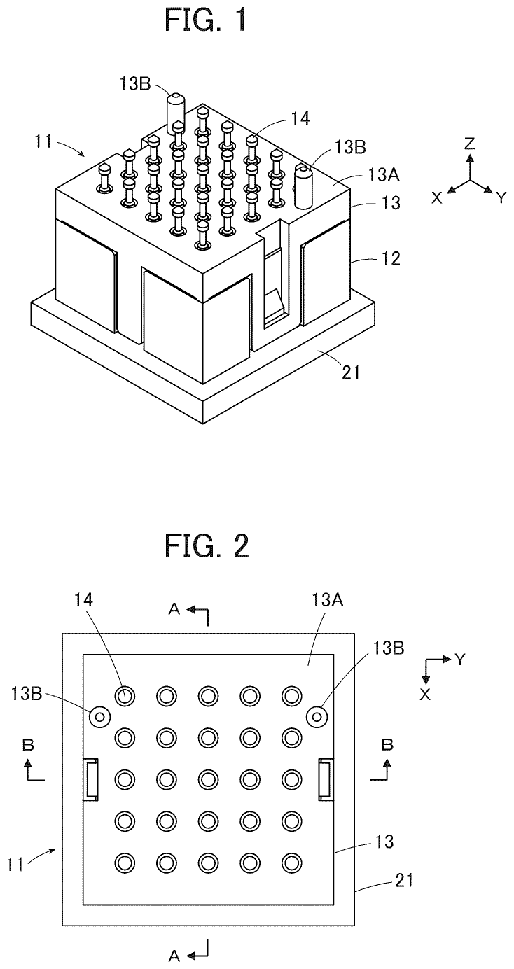

FIGS. 1 to 4 show a connector 11 according to Embodiment 1. The connector 11 is mounted on a mounting substrate 21 and includes a housing 12, a locator 13 retained by the housing 12, and a plurality of contacts 14 retained by the housing 12.

With the housing 12 and the locator 13, the connector 11 has a substantially cuboid shape as a whole. The locator 13 has a pair of bosses 13B projecting perpendicularly from a surface 13A of the locator 13, and the plurality of contacts 14 are disposed such that part of each contact 14 projects from the surface 13A of the locator 13.

In addition, the mounting substrate 21 has a flat plate shape.

For convenience, a plane in which the mounting substrate 21 of flat plate shape extends is referred to as XY plane, a direction in which the pair of bosses 13B of the locator 13 are arranged Y direction, and a direction which is perpendicular to the surface 13A of the locator 13 and in which the pair of bosses 13B project +Z direction.

Part of each of the plurality of contacts 14 projects in the +Z direction from the surface 13A of the locator 13.

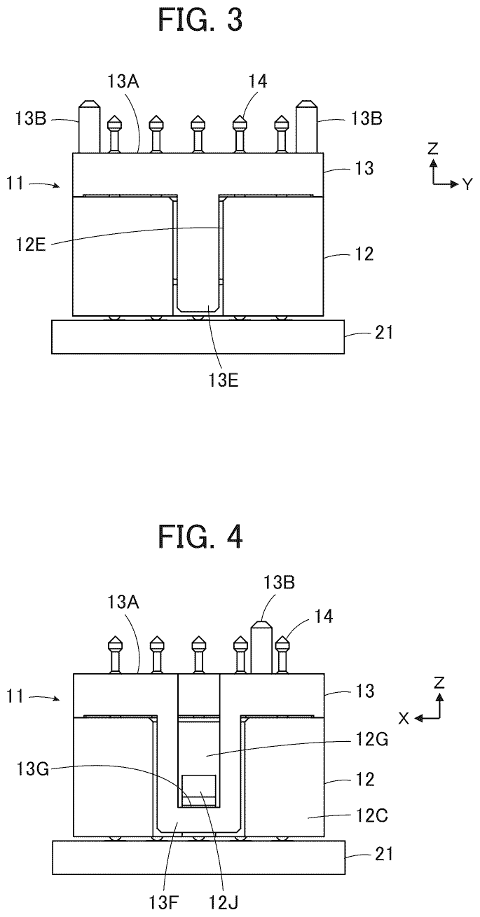

As shown in FIGS. 3 and 4, the pair of bosses 13B of the locator 13 have a height higher than those of the plurality of contacts 14 projecting from the locator 13, i.e., extend to the +Z direction side of the plurality of contacts 14.

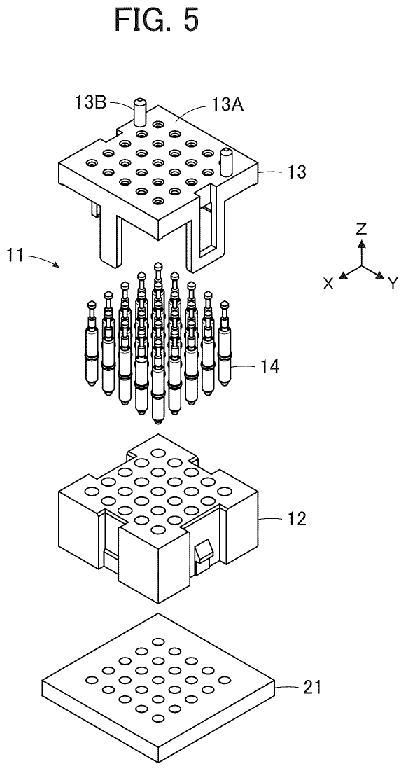

FIG. 5 shows an exploded view of the connector 11. The housing 12 of the connector 11 is disposed on the +Z direction side of the mounting substrate 21, the contacts 14 are disposed on the +Z direction side of the housing 12, and the locator 13 is disposed on the +Z direction side of the contacts 14.

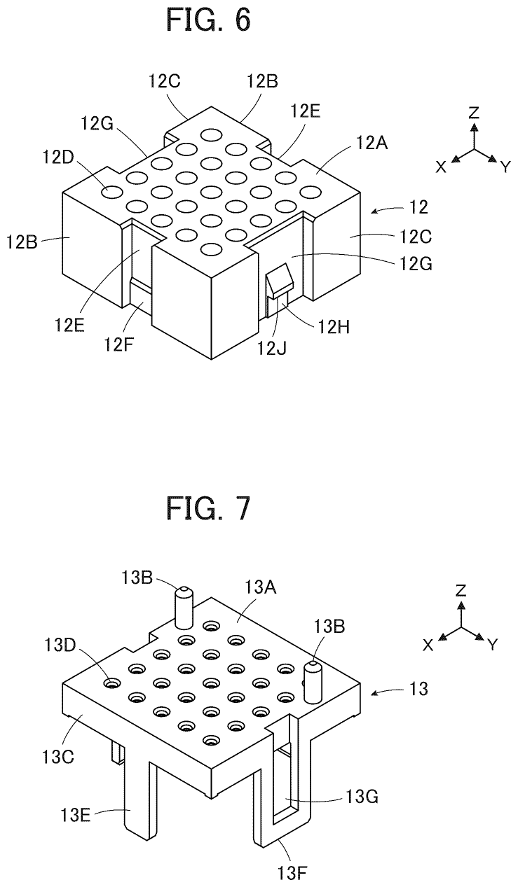

As shown in FIG. 6, the housing 12 is formed of an insulating material and has a substantially cuboid shape. In addition, the housing 12 has a front surface 12A of substantially rectangular shape extending in an XY plane and facing in the +Z direction, a pair of side surfaces 12B extending along the −Z direction separately from the +X directional end portion and the −X directional end portion of the front surface 12A, and a pair of side surfaces 12C extending along the −Z direction from the +Y directional end portion and the −Y directional end portion of the front surface 12A.

The housing 12 is provided with a plurality of contact through-holes 12D penetrating the housing 12 in the Z direction.

In addition, each of the pair of side surfaces 12B of the housing 12 is provided with a groove portion 12E opening in the X direction and extending in the Z direction, and the groove portion 12E is provided at its −Z directional end portion with an X directional step portion 12F.

Similarly, each of the pair of side surfaces 12C of the housing 12 is provided with a groove portion 12G opening in the Y direction and extending in the Z direction. The groove portion 12G has an X directional width wider than a Y directional width of the groove portion 12E of the side surface 12B and is provided at its −Z directional end portion and central portion in the X direction with a Y directional step 12H. Further, a restriction portion 12J projecting in the Y direction is formed at the +Z direction side of the step portion 12H.

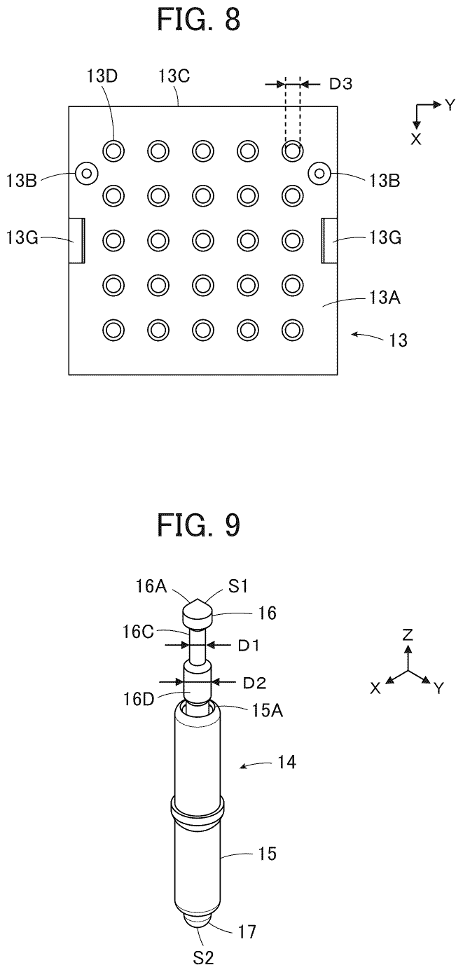

As shown in FIGS. 7 and 8, the locator 13 is formed of an insulating material and has a flat plate portion 13C extending along an XY plane and having a rectangular planar shape when viewed in the Z direction, the +Z directional surface of the flat plate portion 13C forms the surface 13A of the locator 13, and the pair of bosses 13B are formed to project on the surface 13A toward the +Z direction.

In addition, the flat plate portion 13C is provided with a plurality of movable portion insertion holes 13D penetrating the flat plate portion 13C in the Z direction. The plurality of movable portion insertion holes 13D correspond to the plurality of contact through-holes 12D of the housing 12 and each have an inner diameter D3.

Further, the locator 13 has a pair of flat I-shaped arm portions 13E extending in the −Z direction along a YZ plane separately from the +X directional end portion and the −X directional end portion of the flat plate portion 13C, and a pair of flat U-shaped arm portions 13F extending in the −Z direction along an XZ plane separately from the +Y directional end portion and the −Y directional end portion of the flat plate portion 13C. The pair of arm portions 13E are formed so as to be elastically deformable in the X direction while a pair of arm portions 13F are formed so as to be elastically deformable in the Y direction.

The arm portion 13F has a X directional width wider than the Y directional width of the arm portion 13E and has a restricted portion 13G constituted of an opening portion formed on the inner side of its U shape. The restricted portion 13G corresponds to the restriction portion 12J of the housing 12, and the restriction portion 12J projecting in the Y direction is configured to be inserted into and caught by the restricted portion 13G.

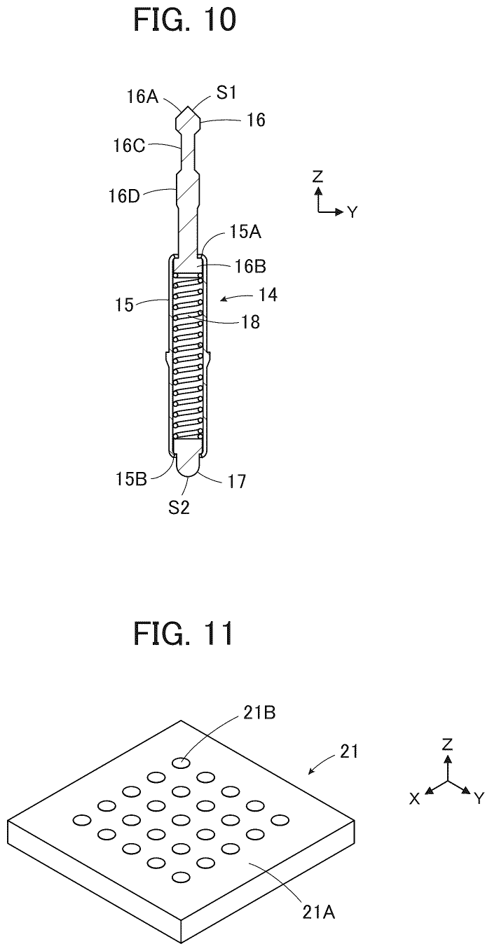

As shown in FIGS. 9 and 10, the contact 14 is made of a conductive material, and has a so-called probe pin structure extending in the Z direction. That is, the contact 14 includes a barrel 15 of tubular shape, a first plunger 16 and a second plunger 17 that are retained by the barrel 15, and a coil spring 18 disposed inside the barrel 15 and between the first plunger 16 and the second plunger 17.

The barrel 15 has an outer diameter corresponding to the inner diameter of the contact through-hole 12D of the housing 12, and when the barrel 15 is press-fitted into the contact through-hole 12D, the contact 14 is retained by the housing 12.

The first plunger 16 constitutes a movable portion, passes through a through-hole 15A formed at the +Z directional end portion of the barrel 15 and is retained by the barrel 15 so as to be elastically displaceable in the Z direction with respect to the barrel 15 by the action of the coil spring 18.

The first plunger 16 includes a front end portion 16A disposed at the +Z directional end portion thereof and projecting in the +Z direction from the barrel 15 and a rear end portion 16B disposed at the −Z directional end portion thereof and received in the barrel 15. The front end portion 16A is provided with a first connection portion S1 of conical shape, and the rear end portion 16B has an outer diameter larger than the inner diameter of the through-hole 15A so as not to be pulled off the barrel 15 in the +Z direction.

In addition, the first plunger 16 has a first extending portion 16C of round columnar shape extending in the −Z direction from the first connection portion S1 and a second extending portion 16D of round columnar shape extending in the −Z direction from the first extending portion 16C. In an XY plane orthogonal to the Z direction, the first extending portion 16C has a first width D1 while the second extending portion 16D has a second width D2 wider than the first width D1 of the first extending portion 16C. Specifically, since the first extending portion 16C and the second extending portion 16D both have a round columnar shape extending in the Z direction, the first width D1 and the second width D2 are represented by the outer diameter of the first extending portion 16C and the outer diameter of the second extending portion 16D, respectively.

The second width D2 of the second extending portion 16D has a dimension slightly smaller than the inner diameter D3 of the movable portion insertion hole 13D of the locator 13, and when the second extending portion 16D is situated inside the movable portion insertion hole 13D, the second extending portion 16D is inserted into the movable portion insertion hole 13D without displacing in an XY plane. On the other hand, when the first extending portion 16C having the first width D1 is situated inside the movable portion insertion hole 13D, a predetermined gap is formed between an outer peripheral surface of the first extending portion 16C and an inner peripheral surface of the movable portion insertion hole 13D, and the first extending portion 16C can be moved in an XY plane within the range of this gap.

In addition, the second plunger 17 passes through a through-hole 15B formed at the −Z directional end portion of the barrel 15 and is retained by the barrel 15 so as to be elastically displaceable in the Z direction with respect to the barrel 15 by the action of the coil spring 18.

A second connection portion S2 projecting in the −Z direction from the barrel 15 is formed at the −Z directional end portion of the second plunger 17, the +Z directional end portion of the second plunger 17 has an outer diameter larger than an inner diameter of the through-hole 15B so as not to be pulled off the barrel 15 in the −Z direction.

The coil spring 18 constitutes a spring portion for elastically displacing the first plunger 16, which serves as the movable portion, in the Z direction, and is disposed between the rear end portion 16B of the first plunger 16 and the +Z directional end portion of the second plunger 17. Specifically, the coil spring 18 applies an elastic force to the first plunger 16 and the second plunger 17, the elastic force pressing these plungers in opposite directions to each other along the Z direction.

As shown in FIG. 11, a mounting substrate 21 on which the connector 11 is to be mounted is made of an insulating material and has a mounting surface 21A facing in the +Z direction, and a plurality of conductive pads 21B are formed on the mounting surface 21A.

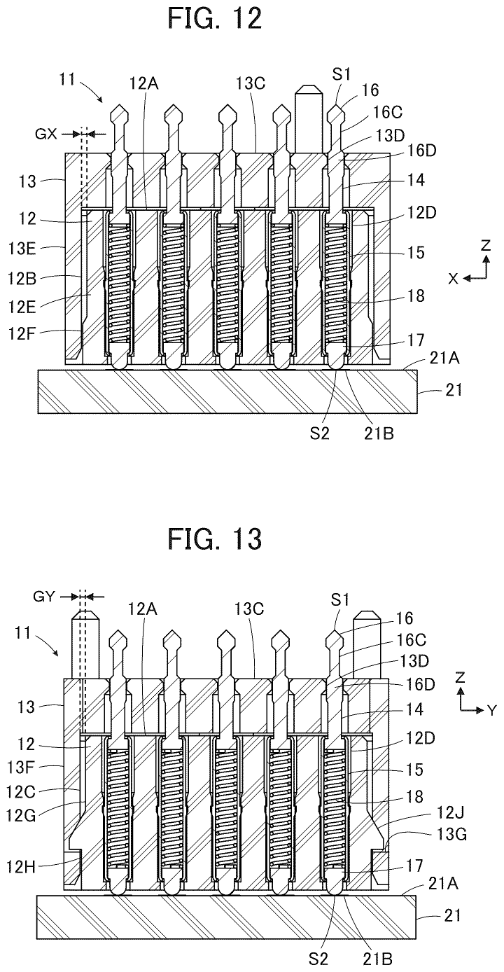

Here, FIGS. 12 and 13 show the connector 11 that is mounted on the mounting substrate 21. The barrels 15 of the plurality of contacts 14 are separately press-fitted into the plurality of contact through-holes 12D of the housing 12, and the locator 13 is disposed on the housing 12. The flat plate portion 13C of the locator 13 covers the front surface 12A of the housing 12, and the first plungers 16 of the plurality of contacts 14 are separately inserted into the plurality of movable portion insertion holes 13D of the flat plate portion 13C of the locator 13. In each contact 14, the first connection portion S1 of the first plunger 16 projects in the +Z direction from the flat plate portion 13C of the locator 13 while the second connection portion S2 of the second plunger 17 projects in the −Z direction from the housing 12.

As shown in FIG. 12, the pair of arm portions 13E of the locator 13 are separately inserted into the groove portions 12E of the pair of side surfaces 12B, facing in the X direction, of the housing 12, and each of the −Z directional end portions of the pair of arm portions 13E makes contact with or is close to the step portion 12F formed at the −Z directional end portion of the corresponding groove portion 12E. Owing to the step portion 12F, a predetermined gap GX is formed between the arm portion 13E of the locator 13 and a +Z directional portion of the groove portion 12E of the housing 12.

The groove portion 12E of the housing 12 is formed to be wider in the Y direction than the arm portion 13E of the locator 13 such that the locator 13 can be moved in the Y direction.

As shown in FIG. 13, the pair of arm portions 13F of the locator 13 are separately inserted into the groove portions 12G of the pair of side surfaces 12C, facing in the Y direction, of the housing 12, and each of the −Z directional end portions of the pair of arm portions 13F makes contact with or is close to the step portion 12H formed at the −Z directional end portion of the corresponding groove portion 12G. Owing to the step portion 12H, a predetermined gap GY is formed between the arm portion 13F of the locator 13 and a +Z directional portion of the groove portion 12G of the housing 12.

The groove portion 12G of the housing 12 is formed to be wider in the X direction than the arm portion 13F of the locator 13 such that the locator 13 can be moved in the X direction.

In addition, when the restriction portions 12J formed at the groove portions 12G of the pair of side surfaces 12C of the housing 12 are separately inserted into and caught by the restricted portions 13G of the pair of arm portions 13F of the locator 13, the locator 13 is restricted not to move in the +Z direction with respect to the housing 12.

Here, the pair of arm portions 13E of the locator 13 are formed to be elastically deformable in the X direction while the pair of arm portions 13F are formed to be elastically deformable in the Y direction; therefore, the flat plate portion 13C is movable within the range of the gap GX and the range of the gap GY along an XY plane with respect to the housing 12.

In addition, the second connection portions S2 of the second plungers 17 of the plurality of contacts 14 projecting in the −Z direction from the housing 12 separately make contact with and are separately electrically connected to the plurality of conductive pads 21B of the mounting substrate 21, whereby the connector 11 is mounted on the mounting surface 21A of the mounting substrate 21. However, the invention is not limited thereto, and the second connection portions S2 may be electrically connected to the conductive pads 21B by soldering.

Since the second plunger 17 is retained by the barrel 15 so as to be elastically displaceable in the Z direction with respect to the barrel 15 by the action of the coil spring 18, even when positional deviation in the Z direction occurs among the plurality of conductive pads 21B of the mounting substrate 21, the second connection portions S2 of the plurality of contacts 14 can be connected to the plurality of conductive pads 21B without fail.

As shown in FIGS. 12 and 13, when no external force other than gravity is applied to the first plunger 16 of each contact 14, the entire first extending portion 16C of the first plunger 16 projects in the +Z direction from the locator 13, and the second extending portion 16D is situated inside the movable portion insertion hole 13D of the locator 13.

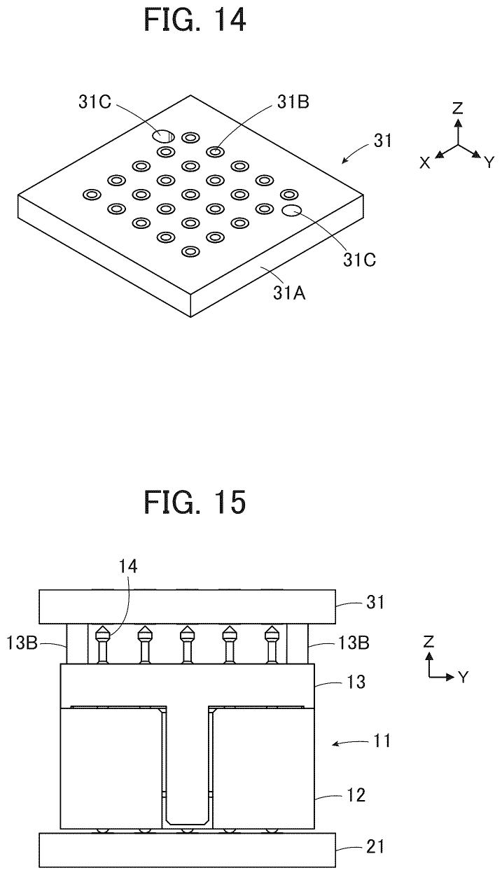

FIG. 14 illustrates a connection object 31 that is connected to the connector 11. The connection object 31 includes a connection substrate 31A of flat plate shape made of an insulating material and extending along an XY plane, and a plurality of counter contacts 31B attached to the connection substrate 31A and corresponding to the plurality of contacts 14 of the connector. The counter contact 31B has a so-called through-hole structure in which a conductive layer (through-hole plating) is formed on an inner peripheral surface and around opposite ends of a through-hole penetrating the connection substrate 31A in the Z direction, and a counter connection portion S3 of annular shape, to be described later, facing in the −Z direction is formed at the −Z directional end portion of the through-hole.

The through-hole constituting the counter contact 31B has an inner diameter smaller than the diameter of the front end portion 16A of the first plunger 16 in which the first connection portion S1 of conical shape is formed in the contact 14 shown in FIG. 9.

Further, the connection substrate 31A is provided with a pair of positioning holes 31C penetrating the connection substrate 31A in the Z direction. The pair of positioning holes 31C correspond to the pair of bosses 13B of the connector 11.

The pair of positioning holes 31C are arranged to be aligned in the Y direction, and of the pair of positioning holes 31C, the positioning hole 31C arranged on the +Y direction side forms a through-hole having a circular cross-sectional shape while the positioning hole 31C arranged on the −Y direction side forms a through-hole having an oval cross-sectional shape elongated in the Y direction.

When the connection object 31 is connected to the connector 11 to form the connector assembly, first, as shown in FIG. 15, the connection object 31 is moved from the +Z direction in the −Z direction toward the connector 11, and the tips of the pair of bosses 13B of the locator 13 are inserted into the pair of positioning holes 31C of the connection object 31, whereby the connector 11 and the connection object 31 are aligned in an XY plane.

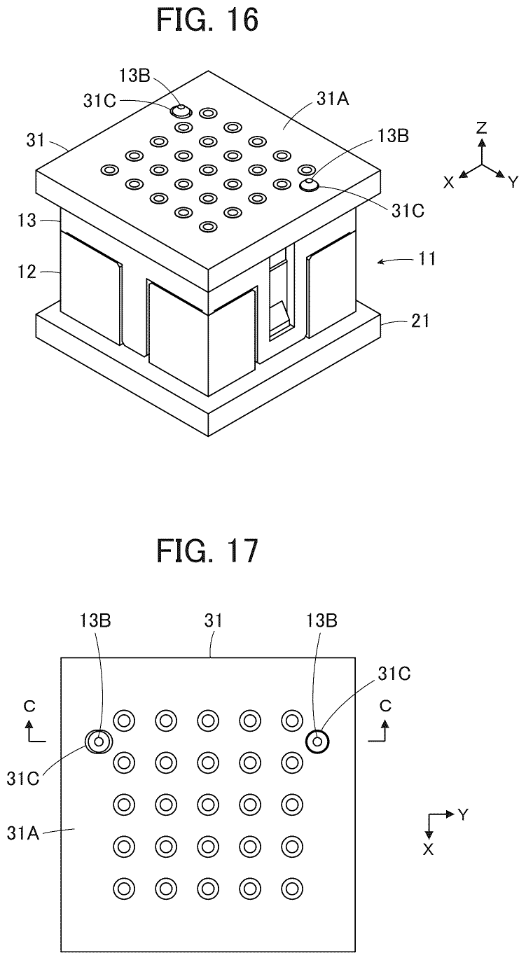

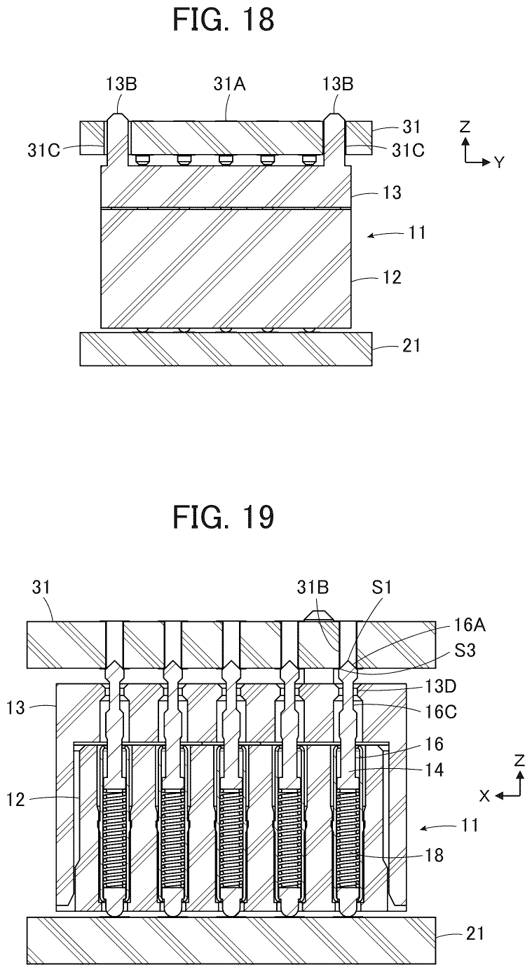

When the connection object 31 is moved further toward the connector 11, the first plungers 16 of the plurality of contacts 14 projecting in the +Z direction from the locator 13 are pressed in the −Z direction by means of the connection object 31, and as shown in FIGS. 16 to 18, the pair of bosses 13B of the locator 13 pass through the pair of positioning holes 31C of the connection object 31.

At this time, since the positioning hole 31C on the +Y direction side of the pair of positioning holes 31C of the connection substrate 31A has a circular cross-sectional shape while the positioning hole 31C on the −Y direction side has an oval cross-sectional shape elongated in the Y direction, even when positional deviation occurs between the pair of bosses 13B of the locator 13 and the pair of positioning holes 31C of the connection substrate 31A due to their manufacturing tolerances or the like, the pair of bosses 13B are inserted into the pair of positioning holes 31C, whereby the connector 11 and the connection object 31 can be positioned with respect to each other.

When the connection object 31 is moved toward the connector 11 in this manner, as shown in FIG. 19, the first connection portions S1 of conical shape formed at the front end portions 16A of the first plungers 16 of the plurality of contacts 14 are separately inserted into the through holes of the corresponding counter contacts 31B of the connection object 31. The counter connection portion S3 of annular shape is formed at the −Z directional end portion of the through-hole of the counter contact 31B, and when the connection object 31 is pressed toward the connector 11, the counter connection portions S3 of the plurality of counter contacts 31B of the connection object 31 make contact with the first connection portions S1 of the plurality of the plurality of contacts 14 and push the first connection portions S1 toward the −Z direction, whereby the first plunger 16 of each contact 14 is elastically displaced in the −Z direction while compressing the coil spring 18, and as a result, the first extending portion 16C of the first plunger 16 is situated inside the movable portion insertion hole 13D of the locator 13.

Therefore, a predetermined gap is formed between the outer peripheral surface of the first extending portion 16C and the inner peripheral surface of the movable portion insertion hole 13D, and the first extending portion 16C can be moved in an XY plane within the range of this gap. That is, the first connection portion S1 of conical shape formed at the front end portion 16A of the first plunger 16 can be moved in an XY plane, and even when positional deviation occurs between the contact 14 of the connector 11 and the counter contact 31B of the connection object 31 due to their manufacturing tolerances or the like, the first connection portion S1 of conical shape of the contact 14 makes contact with the counter connection portion S3 of the counter contact 31B in the state where the center of the first connection portion S1 coincides with the center of the counter contact portion S3. In other words, the first connection portion S1 and the counter connection portion S3 together form a contact site having a shape close to a circle and make contact with each other at the substantially entire circumference of this contact site. Therefore, a connector assembly which ensures the reliability of electrical connection between the contact 14 and the counter contact 31B can be realized.

As described above, when no external force other than gravity is applied to the first plungers 16 of the plurality of contacts 14, the second extending portion 16D of each contact 14 is situated inside the movable portion insertion hole 13D of the locator 13 without displacing in an XY plane; however, the pair of arm portions 13E of the locator 13 are formed to be elastically deformable in the X direction while the pair of arm portions 13F are formed to be elastically deformable in the Y direction.

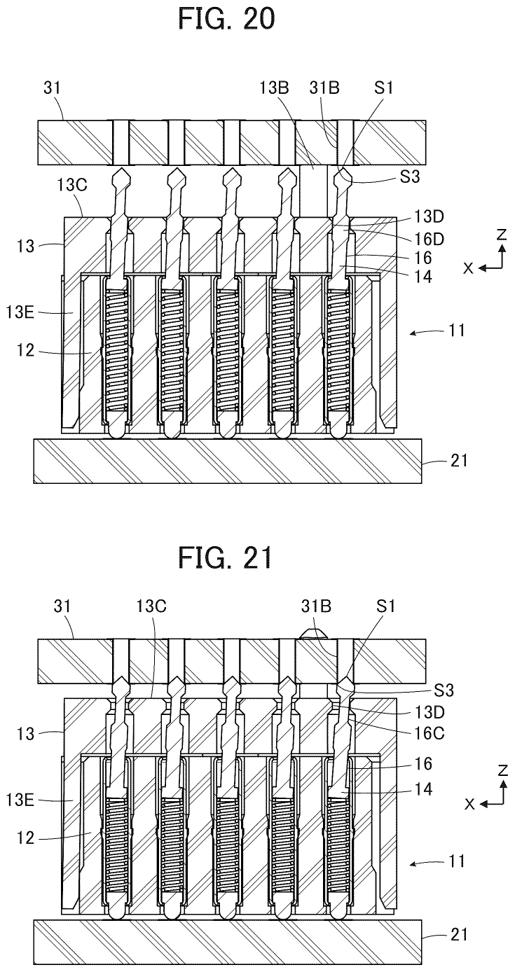

Therefore, as shown in FIG. 20, when the connection object 31 is positionally deviated in the −X direction with respect to the connector 11 and the tips of the pair of bosses 13B of the locator 13 are inserted into the pair of positioning holes 31C of the connection object 31 for example, of the pair of arm portions 13E of the locator 13, the arm portion 13E on the +X direction side is elastically deformed, whereby the flat plate portion 13C is moved in the −X direction with respect to the housing 12, and the second extending portions 16D of the plurality of contacts 14 are moved in the −X direction together with the locator 13.

As a result, the first plungers 16 of the plurality of contacts 14 are tilted, and the plurality of first connection portions S1 are moved in the −X direction and are situated on the −Z direction side of the counter connection portions S3 of the plurality of counter contacts 31B of the connection object 31 that is positionally deviated in the −X direction.

When the connection object 31 is pressed toward the connector 11 in this state, as shown in FIG. 21, the counter connection portions S3 of the plurality of counter contacts 31B of the connection object 31 make contact with the first connection portions S1 of the plurality of contacts 14 and push the first connection portions S1 to the −Z direction, whereby the first connection portions S1 of conical shape make contact with the counter connection portions S3 in the state where the center of each of the first connection portions S1 coincides with the center of each of the counter connection portions S3. As a result, the plurality of contacts 14 and the plurality of counter contacts 31B are electrically connected to each other.

Even when the connection object 31 is positionally deviated in the +X direction with respect to the connector 11, similarly, the plurality of contacts 14 and the plurality of counter contacts 31B can be electrically connected to each other.

In addition, when the connection object 31 is positionally deviated in the +Y direction or the −Y direction with respect to the connector 11, one arm portion 13F of the pair of arm portions 13F of the locator 13 is elastically deformed so that the flat plate portion 13C is moved in the +Y direction or the −Y direction with respect to the housing 12, and similarly, the plurality of contacts 14 and the plurality of counter contacts 31B are electrically connected to each other.

In addition, when the connection object 31 is pressed toward the connector 11, the first extending portion 16C of the first plunger 16 of each contact 14 is situated inside the movable portion insertion hole 13D of the locator 13; therefore, even when the positions of the plurality of counter contacts 31B of the connection object 31 vary in an XY plane, the first extending portion 16C is moved within the range of the predetermined gap formed between the outer peripheral surface of the first extending portion 16C and the inner peripheral surface of the movable portion insertion hole 13D, whereby the first connection portion S1 of conical shape of the contact 14 can make contact with the counter connection portion S3 in the state where the center of the first connection portion S1 coincides with the center of the counter connection portion S3, so the reliability of electrical connection between the contact 14 and the counter contact 31B is ensured.

Similarly, it is possible to improve the reliability of electrical connection between the plurality of contacts 14 and the plurality of counter contacts 31B even when variation is present in the positions in an XY plane of the plurality of contacts 14 of the connector 11.

As shown in FIGS. 20 and 21, in order for the first plunger 16 of each contact 14 not to interfere with the barrel 15 when it is tilted, the first plunger 16 is provided, at a position adjacent to the second extending portion 16D on the −Z direction side thereof, with a portion having a width narrower than that of the second extending portion 16D.

### Embodiment 2

In Embodiment 1 above, the first connection portion S1 of conical shape of the contact 14 in the connector 11 makes contact with the counter contact 31B, having the through-hole structure, of the connection object 31, but the invention is not limited thereto.

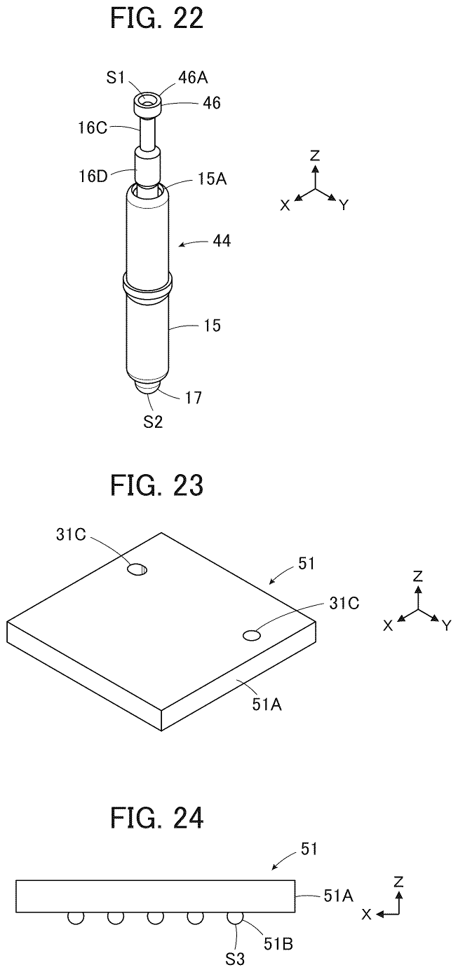

FIG. 22 shows a contact 44 used in Embodiment 2. The contact 44 is the same as the contact 14 in Embodiment 1 except that a first plunger 46 is used in place of the first plunger 16 in the contact 14 shown in FIGS. 9 and 10 in Embodiment 1.

That is, the contact 44 includes a barrel 15 of tubular shape, the first plunger 46 and a second plunger 17 each retained by the barrel 15, and the coil spring 18 shown in FIG. 10 is disposed inside the barrel 15 and between the first plunger 46 and the second plunger 17.

While the first plunger 16 of the contact 14 in Embodiment 1 includes the first connection portion S1 of conical shape formed at the front end portion 16A, the first plunger 46 of the contact 44 in Embodiment 2 includes a first connection portion S1 of annular shape formed at a front end portion 46A. The remaining configuration of the first plunger 46 is the same as that of the plunger 16 in Embodiment 1.

That is, the first plunger 46 constitutes a movable portion, passes through a through-hole 15A formed at the +Z directional end portion of the barrel 15, and is retained by the barrel 15 to be elastically displaceable in the Z direction with respect to the barrel 15 by the action of the coil spring 18. In addition, the first plunger 46 includes the first extending portion 16C of round columnar shape extending in the −Z direction from the first connection portion S1 of annular shape and the second extending portion 16D of round columnar shape extending in the −Z direction from the first extending portion 16C.

FIGS. 23 and 24 show a connection object 51 used in Embodiment 2. The connection object 51 is obtained by forming a plurality of counter contacts 51B of so-called bump electrode shape on the −Z directional surface of a connection substrate 51A, in place of the plurality of counter contacts 31B each having the through-hole structure formed in the connection substrate 31A in the connection object 31 used in Embodiment 1. Each counter contact 51B includes a counter connection portion S3 of spherical shape facing in the −Z direction.

In addition, as with the connection substrate 31A of the connection object 31 in Embodiment 1, the connection substrate 51A is provided with the pair of positioning holes 31C.

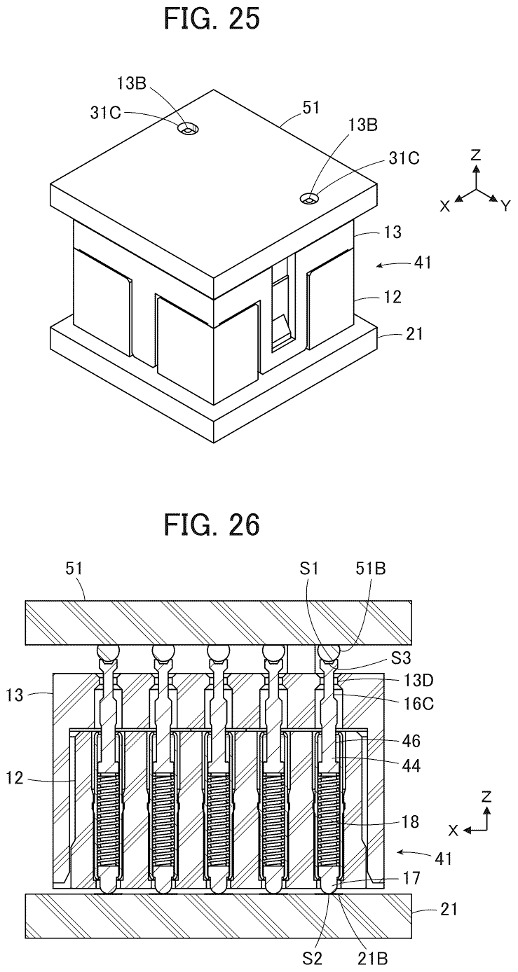

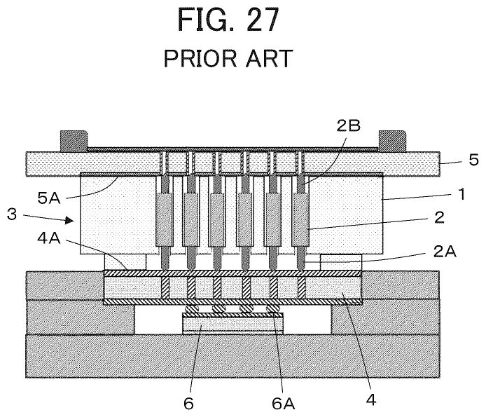

When the connector 41 of Embodiment 2 is connected to the connection object 51 to form a connector assembly, as shown in FIG. 25, similarly in Embodiment 1, the connection object 51 is pressed toward the connector 41 in the state where the pair of bosses 13B of the locator 13 are inserted into the pair of positioning holes 31C of the connection object 51.

Thus, as shown in FIG. 26, when the counter connection portions S3 of spherical shape of the plurality of counter contacts 51B of the connection object 51 make contact with the first connection portions S1 of annular shape of the plurality of contacts 44 and push the first connection portions S1 in the −Z direction, the first plunger 46 of each contact 44 is elastically displaced in the −Z direction while compressing the coil spring 18, and as a result, the first extending portion 16C of the first plunger 46 is situated inside the movable portion insertion hole 13D of the locator 13.

As a result, the first connection portion S1 of annular shape of the first plunger 46 can be moved in an XY plane, and even when positional deviation occurs between the contact 44 of the connector 41 and the counter contact 51B of the connection object 51 due to their manufacturing tolerances or the like, the first connection portion S1 of annular shape of the contact 44 makes contact with the counter connection portion S3 of spherical shape of the counter contact 51B, whereby the reliability of electrical connection between the contact 44 and the counter contact 51B can be secured.

Further, even when the positions of the plurality of counter contacts 51B of the connection object 51 vary in an XY plane or even when the positions of the plurality of contacts 44 vary in an XY plane in the connector 41, as with Embodiment 1, the reliability of electrical connection between the plurality of contacts 44 and the plurality of counter contacts 51B can be improved.

Also in Embodiment 2, the second connection portions S2 of the second plungers 17 of the plurality of contacts 44 project in the −Z direction from the housing 12, and these second connection portions S2 separately make contact with and are electrically connected separately to the plurality of conductive pads 21B of the mounting substrate 21, whereby the connector 41 is mounted on the mounting substrate 21. However, the invention is not limited thereto, and the second connection portions S2 may be electrically connected to the conductive pads 21B by soldering.

The contact 14 used in Embodiment 1 and the contact 44 used in Embodiment 2 both have a so-called probe pin structure in which the coil spring 18 is disposed between the first plunger 16, 46 and the second plunger 17, but the invention is not limited thereto. For example, the contact can be formed by cutting and bending a single metal sheet.

However, also in this case, the contact needs to have a movable portion that is elastically displaceable in the Z direction with respect to the housing 12, and the movable portion needs to include a first connection portion, a first extending portion having a first width, and a second extending portion having a second width wider than the first width.

In addition, at least one bending portion is formed in the metal sheet that is connected to the movable portion so that a spring portion for elastically displacing the movable portion can be formed.

Further, of the metal sheet, the thickness of a portion constituting the first extending portion and the thickness of a portion constituting the second extending portion are set to be different from each other, whereby the second extending portion having a second width wider both in the X direction and the Y direction than the first width of the first extending portion can be formed.

While the plurality of counter contacts 31B, 51B of the connection object 31, 51 are connected to the plurality of contacts 14, 44 of the connector 11, 41 in Embodiments 1 and 2, the number of the counter contacts 31B, 51B and the number of contacts 14, 44 are not limited, and a single counter contact of the connection object may be connected to a single contact of the connector.

In Embodiments 1 and 2, the second connection portions S2 of the plurality of contacts 14, 44 are separately connected to the plurality of conductive pads 21B of the mounting substrate 21 so that the connector 11, 41 is mounted on the mounting substrate 21, but the invention is not limited thereto, and for example, the plurality of contacts 14, 44 are electrically connected to a plurality of signal lines of a cable with known various connection methods.

Further, in Embodiments 1 and 2, the pair of bosses 13B of the locator 13 are inserted into the pair of positioning holes 31C of the connection object 31, 51 so that the connection object 31, 51 is positioned with respect to the connector 11, 41, but the invention is not limited thereto, and for example, positioning may be performed by guiding the outer peripheral portion of the connection substrate 31A, 51A of the connection object 31, 51 by means of the locator 13.

What is claimed is:

1. A connector that is connected to a connection object by an operation of pressing the connection object to the connector along a predetermined pressing direction, the connector comprising:
a housing that is made of an insulating material and has a front surface facing the connection object;
a contact that is conductive, is retained by the housing, and extends along the pressing direction; and
a locator that is made of an insulating material and retained by the housing to cover the front surface of the housing,
wherein the contact includes a movable portion that is elastically displaceable in the pressing direction with respect to the housing and that at least partly projects from the locator toward the connection object,
wherein the movable portion includes:
a front end portion facing the connection object along the pressing direction;
a first connection portion disposed at the front end portion;
a first extending portion extending from the first connection portion in an opposite direction opposite from the front end portion along the pressing direction and having a first width in an orthogonal direction orthogonal to the pressing direction; and
a second extending portion extending from the first extending portion in the opposite direction from the front end portion along the pressing direction and having a second width wider than the first width in the orthogonal direction,
wherein the locator has a movable portion insertion hole that allows the second extending portion of the movable portion to be inserted therethrough,
wherein when the connection object is not pressed to the connector, the second extending portion is situated inside the movable portion insertion hole of the locator, and the first extending portion projects from the locator toward the connection object, and when the connection object is pressed to the connector, a counter contact of the connection object makes contact with the first connection portion and pushes the first connection portion in the pressing direction, whereby the movable portion is elastically displaced in an opposite direction from the connection object so that the first extending portion is situated inside the movable portion insertion hole of the locator.

2. The connector according to claim 1, wherein the contact includes: a second connection portion disposed at an end portion of the contact in an opposite direction from the connection object; and a spring portion disposed between the movable portion and the second connection portion and allowing the movable portion to be elastically displaced along the pressing direction.

3. The connector according to claim 2, wherein
the contact is constituted of a probe pin that includes a barrel extending in the pressing direction and a plunger constituting the movable portion and being retained by the barrel so as to be elastically displaceable along the pressing direction, and
the spring portion is disposed inside the barrel.

4. The connector according to claim 3, wherein
the housing has a contact through-hole through which the contact penetrates, and
the barrel is retained in the contact through-hole.

5. The connector according to claim 1, wherein
the housing has a side surface extending from an end portion of the front surface along the pressing direction, and a restriction portion formed in the side surface,
the locator has a flat plate portion extending in the orthogonal direction to cover the front surface of the housing, an arm portion extending from an end portion of the flat plate portion along the side surface of the housing, and a restricted portion formed in the arm portion,
the restriction portion is caught by the restricted portion so that the locator is restricted to move in the pressing direction with respect to the housing, and
the movable portion insertion hole is formed in the flat plate portion.

6. The connector according to claim 5, wherein the locator is retained by the housing such that the flat plate portion is movable in the orthogonal direction with respect to the housing.

7. The connector according to claim 1, wherein
each of the first extending portion and the second extending portion has a round columnar shape extending along the pressing direction, and
the first width and the second width are represented by an outer diameter of the first extending portion and an outer diameter of the second extending portion, respectively.

8. The connector according to claim 1, wherein
a plurality of the contacts are retained by the housing,
the locator has a plurality of the movable portion insertion holes corresponding to the plurality of the contacts, and
a plurality of the counter contacts of the connection object separately make contact with the first connection portions of the plurality of the contacts.

9. A connector assembly comprising:
the connector according to claim 1; and
the connection object.

10. The connector assembly according to claim 9, wherein
the locator has a boss projecting along the pressing direction, and
the connection object has a positioning hole into which the boss is inserted.

11. The connector assembly according to claim 9, wherein
the contact includes the first connection portion of conical shape, and
the counter contact of the connection object has a counter connection portion of annular shape to make contact with the first connection portion.

12. The connector assembly according to claim 9, wherein
the contact includes the first connection portion of annular shape, and
the counter contact of the connection object has a counter connection portion of spherical shape to make contact with the first connection portion.
